(19) United States
(12) Patent Application Publication
(10) Pub. No.: US 2023/0278410 A1
(43) Pub. Date: Sep. 7, 2023

(54) BATTERY MOUNTING ASSEMBLY FOR ELECTRIC VEHICLE

(71) Applicant: Electric Last Mile, Inc., Wilmington, DE (US)

(72) Inventor: Samuel Zeng, Rochester Hills, MI (US)

(73) Assignee: Electric Last Mile, Inc., Wilmington, DE (US)

(21) Appl. No.: 17/962,986

(22) Filed: Oct. 10, 2022

Related U.S. Application Data
(60) Provisional application No. 63/232,341, filed on Aug. 12, 2021.

(51) Int. Cl. B60K 1/04; B60L 50/60; F16F 7/12; H01M 50/242; H01M 50/249; H01M 50/262

(52) U.S. Cl. CPC B60K 1/04; B60L 50/66; F16F 7/12; H01M 50/242; H01M 50/249; H01M 50/262; B60K 2001/0438; F16F 2232/02; F16F 2236/08

(57) ABSTRACT

Systems and methods herein are directed to a battery mounting assembly for an electric vehicle. The battery mounting assembly may include a mount. The mount may include an aperture to receive a portion of a fastener. The mount may include a shock absorber coupled to the mount. The mount may couple to a beam of the electric vehicle. The mount may be configured such that the portion of the fastener exits the aperture at a threshold impact energy.

### CROSS REFERENCE TO RELATED APPLICATION

This application claims the benefit of U.S. Provisional Application No. 63/232,341 filed on Aug. 12, 2021.

### BACKGROUND

The present disclosure relates generally to a battery mounting assembly for an electric vehicle. More specifically, the present disclosure relates to a battery mounting assembly configured to protect an electric battery of the vehicle from damage during impact.

### SUMMARY

One embodiment relates to a battery mounting assembly for an electric vehicle. The battery mounting assembly may include a mount. The mount may include an aperture to receive a portion of a fastener. The mount may include a shock absorber coupled to the mount. The mount may couple to a beam of the electric vehicle. The mount may be configured such that the portion of the fastener exits the aperture at a threshold impact energy.

One embodiment relates to an electric vehicle. The electric vehicle may include a first end and an opposing second end. The electric vehicle may include a plurality of battery mounting assemblies. The electric vehicle may include a battery assembly coupled to a portion of each of the battery mounting assemblies. The battery mounting assemblies may couple to each of the battery assemblies by a fastener. Each of the battery mounting assemblies may include a mount having an aperture to receive a portion of the fastener and a shock absorber coupled to the mount. The mount may be configured such that the portion of the fastener exits the aperture at a threshold impact energy.

One embodiment relates to a battery mounting assembly for an electric vehicle. The battery mounting assembly may include a mount including having aperture to receive a portion of a fastener. The battery mounting assembly may include a torsion bar to couple to a portion of the fastener. The torsion bar may rotate at a threshold impact energy. The torsion bar may couple to a portion of a battery assembly of the electric vehicle.

One embodiment relates to a method of absorbing energy of a front-body impact of an electric vehicle. The method may include providing a battery mounting assembly. The mounting assembly may include a mount having an aperture to receive a portion of fastener and a shock absorber coupled to the mount. The method may include deforming, via the aperture, the mount at a threshold impact energy. The mount may deform such that the portion of the fastener is configured to exit the aperture. The method may include receiving, via the shock absorber, the portion of the fastener.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a bottom perspective view of an electric vehicle, according to an exemplary embodiment.

FIG. 2 is a bottom view of the electric vehicle of FIG. 1, according to an exemplary embodiment.

FIG. 3 is a side perspective view of a portion of the electric vehicle of FIG. 1, according to an exemplary embodiment.

FIG. 4 is a rear perspective view of a portion of the electric vehicle of FIG. 1, according to an exemplary embodiment.

FIG. 5 is a side view of a battery mounting assembly of the electric vehicle of FIG. 1, according to an exemplary embodiment.

FIG. 6 is a side exploded view of the battery mounting assembly of FIG. 7, according to an exemplary embodiment.

FIG. 7 is an example of an impact of the electric vehicle of FIG. 1, according to an exemplary embodiment.

FIG. 8 is an example of an effect of impact on the electric vehicle of FIG. 1, according to an exemplary embodiment.

FIG. 9 is a graphic example of an impact of the electric vehicle of FIG. 1, according to an exemplary embodiment.

FIG. 10 is a perspective view of a battery mounting assembly of the electric vehicle of FIG. 1, according to an exemplary embodiment.

FIG. 11 is an illustration of a process of absorbing energy of an impact of an electric vehicle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, an electric vehicle or hybrid-electric vehicle can include an electric battery assembly. In some electric vehicles, the electric battery assembly is connected to a beam of the electric vehicle, such as the longitudinal beam or a lateral beam (e.g., cross bar) via one or more shafts, rods, or the like. In such cases, front-body impacts, such as crashes and collisions, can create a force on the electric battery assembly, causing the electric battery assembly to be subject to movement. To reduce damage of the battery assembly due to such movement, a battery mounting assembly can facilitate coupling the electric battery assembly to the one or more beams of the electric battery assembly. The battery mounting assembly can include a mount having an aperture for receiving a portion of the battery assembly, such as fastener of a shaft or rod. Upon high impact energy, the mount can deform at the aperture such that the portion of the fastener may be configured to exit the aperture. In various embodiments, the portion of the fastener may exit the aperture and engage with a shock absorber, to absorb the energy of impact.

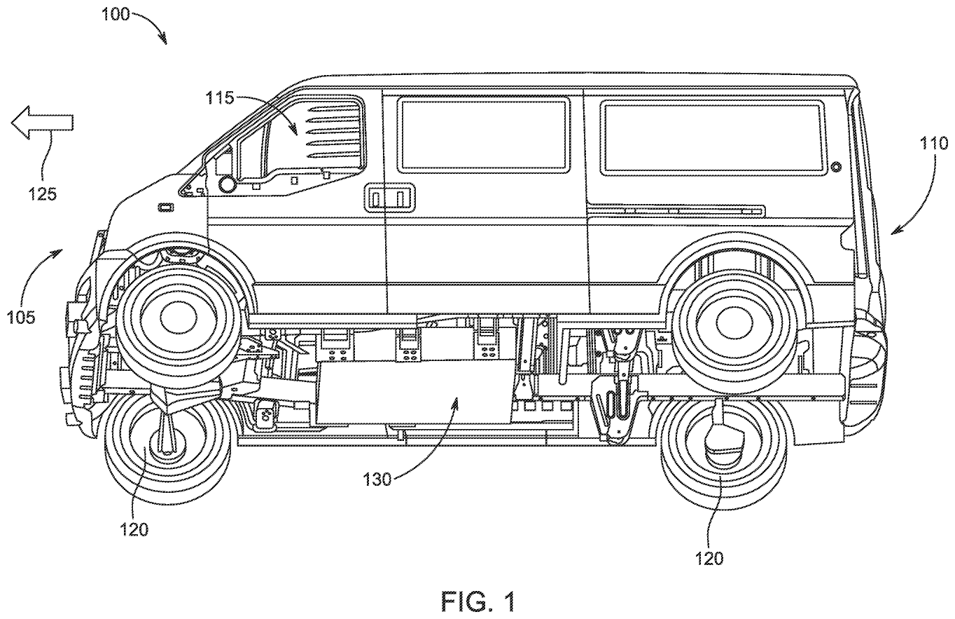

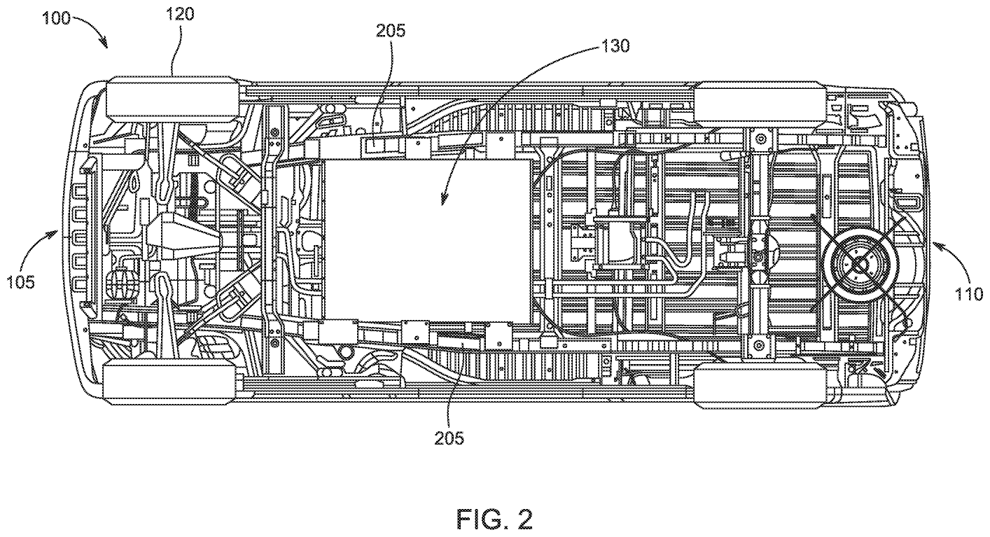

As shown in FIGS. 1 and 2, an electric vehicle 100 can include a first end 105 and a second end 110 opposing the first end 105. For example, the first end 105 can be positioned towards the front of the electric vehicle 100 such that, in a normal operating position, the first end 105 is at the front of a forward direction of travel, as shown in arrow 125. The electric vehicle 100 can include an operating cabin 115, shown as cabin 115. Generally, the operating cabin 115 can be enclosed by a body, frame, or outermost portion of the electric vehicle 100. For example, the body of the electric vehicle 100 can include a frame and a plurality of wheels 120 coupled to the frame for movably supporting the electric vehicle 100 relative to a plane (e.g., road, ground, etc.).

By way of example, the operating cabin 115 can include one or more seats for a user to operate the electric vehicle 100. According to another example, the electric vehicle 100 may be operated autonomously or semi-autonomously (e.g., vehicle includes a sensor for automatic steering, etc.). The electric vehicle 100 can include two front wheels 120 and two rear wheels 120, as shown in FIG. 1. The electric vehicle 100 can include one or more longitudinal beams 205. For example, the longitudinal beams 205 can extend longitudinally from the first end 105 of the vehicle 100 to the second end 110 of the vehicle 100. The electric vehicle 100 can include an electric battery assembly 130. For example, the electric battery assembly 130 can include an electric battery and several components to couple the electric battery with the electric vehicle 100 including, but not limited to, fasteners, shafts, rods, fixtures, axles, bearings, brackets, and various fastening components. As discussed in greater detail below, the electric battery assembly 130 can couple to a portion of the longitudinal beams 205 of the electric vehicle 100. In various other embodiments, the electric battery assembly 130 can couple to a portion of a different beam (e.g., rod, shaft, axle) of the electric vehicle 100, such as a cross bar.

Generally, the electric vehicle 100 can operate by receiving a charge to the electric battery through one or more means including, but not limited to, an aerial vehicle charging system, an emergency charging system, and a highway charging system. In one embodiment, the electric battery assembly 130 can be positioned on an underside of the electric vehicle, as shown in FIG. 2. In one embodiment, the electric vehicle 100 is configured as an on-road vehicle such as a sedan, a sport utility vehicle (“SUV”), a pickup truck, a van, and/or still another type of passenger vehicle. In other embodiments, the electric vehicle 100 is configured as another type of on-road vehicle such as a semi-truck, a bus, or the like. In still other embodiments, the electric vehicle 100 is configured as an off-road vehicle such as construction machinery, farming machinery, or the like.

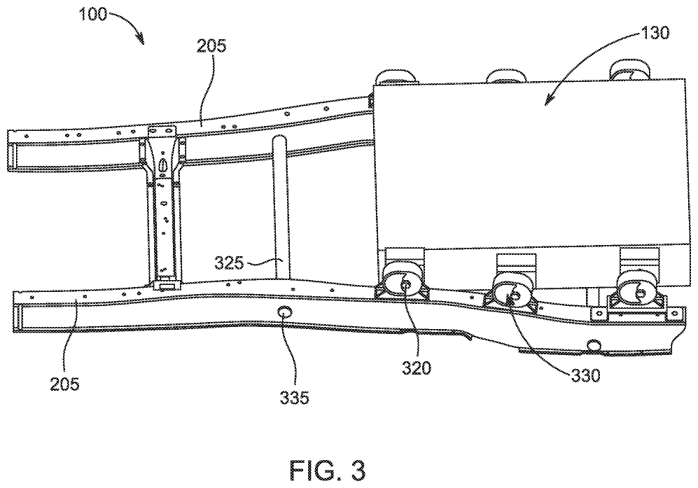

FIG. 3 depicts a side perspective view of a portion of the electric vehicle 100, according to an exemplary embodiment. As shown in FIG. 3, the electric battery assembly 130 can couple to a portion of a longitudinal beam 205 of the electric vehicle 100. For example, the electric vehicle 100 can include one or more shafts 325 (e.g., rods, poles, beams, etc.) that support the electric battery assembly 130. The shafts 325 can facilitate coupling the electric battery assembly 130 to one or more of the longitudinal beams 205 of the electric vehicle 100. For example, a battery mounting assembly 330 can receive a fastener 335 coupled to the shaft 325 to facilitate coupling the electric battery assembly 130 to the longitudinal beams 205, as discussed in greater detail below.

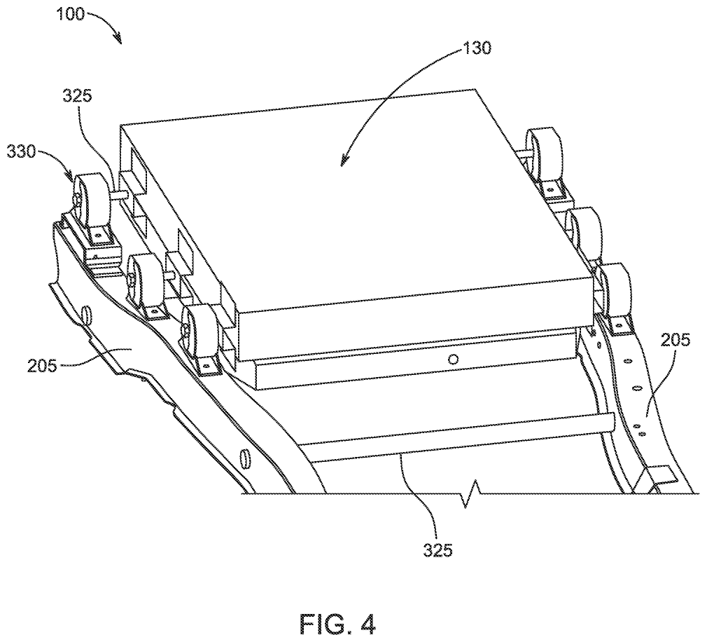

FIG. 4 depicts a rear perspective view of a portion of the electric vehicle 100, according to an exemplary embodiment. As shown in FIG. 4, the shaft 325 can extend through a portion of the battery mounting assembly 330 and a portion of the battery assembly 130. For example, two battery mounting assemblies 330 can support the shaft 325 such that the electric battery assembly 130 attaches to two longitudinal beams 205 of the vehicle 100. In various other embodiments, more or less battery mounting assemblies 330 may support the shaft 325. In various embodiments, the electric vehicle 100 may include more or less longitudinal beams 205.

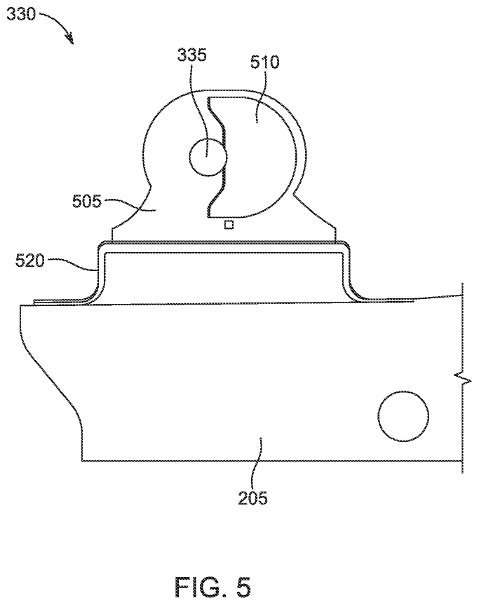

FIG. 5 depicts a portion of the battery mounting assembly 330, according to an exemplary embodiment. As shown in FIG. 5, the battery mounting assembly 330 can include a mount 505. For example, the mount 505 can include one or more elements comprising various metallic and non-metallic materials including, but not limited to, aluminum, aluminum alloys, steel, plastic, and fiber glass. The mount 505 can include a frame or exterior configured to be coupled to the longitudinal beam 205. For example, the battery mounting assembly 330 can include a fixture 520 configured to couple the mount 505 to a portion of the longitudinal beam 205. In various embodiments, the fixture 520 can couple the mount 505 to the longitudinal beam 205 through various fasteners. In various other embodiments, the fixture 520 can couple the mount 505 to the longitudinal beam 205 via welding and/or various other adhesives. In still other embodiments, the mount 505 can couple directly to the longitudinal beam 205 through fasteners, welding, adhesives, or other similar means. In some embodiments, the fixture 520 can be made from a metallic material such as aluminum or steel. In other embodiments, the fixture 520 can be made from a non-metallic material such as plastic or other similar materials. In some embodiments, the fixture 520 can be a thin sheet of material formed with various flanges or other similar components to support coupling the mount 505 with the longitudinal beam 205.

In some embodiments, the battery mounting assembly 330 can include one or more shock absorbers 510. For example, the shock absorber 510 can be coupled with, or integrally formed with, the mount 505. The shock absorber 510 can be made of various metallic or non-metallic materials. For example, in some embodiments, the shock absorber 510 includes a hollow frame made from a malleable and/or soft metal such as an aluminum alloy. In various other embodiments, the shock absorber 510 includes a hollow frame made from a non-metallic material such as fiber glass or plastic. In still other embodiments, the shock absorber 510 includes a solid, continuous component made of a metallic material, a non-metallic material, or a combination thereof. The shock absorber 510 may be configured to deform. For example, the shock absorber 510 may include one or more materials configured to deform upon impact including, but not limited to, plastic, metal, nomex honeycomb, resins, fiber glass, or the like. The shock absorber 510 can include one or more features to facilitate deformation upon impact. For example, the shock absorber 510 can include one or more apertures, guide lines, or other similar features to facilitate buckling, deforming, and/or collapsing with force.

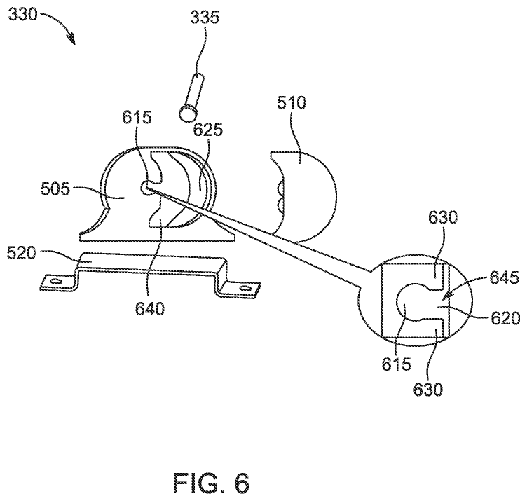

As depicted in FIG. 6, in some embodiments, the battery mounting assembly 330 can include one or more apertures. For example, the mount 505 can include an aperture 615 (e.g., hole, opening, slot, etc.) for receiving the fastener 335 coupled to the shaft 325. The aperture 615 can have a general “C” shape, as shown in FIG. 6. For example the mount 505 can include a latch 645 having arms 630 that surround a portion of the aperture 615 to form such shape. The latch 645 may include a component coupled to the mount 1005 (e.g., a fastener, a clamp, a spring, etc.). In other examples, the latch 645 may be directly formed with the mount 505 such that the mount 505 and the latch 645 form one singular component. In various embodiments, the arms 630 of the latch 645 may secure the fastener 335 within the aperture 615 during normal operation. In various embodiments, the arms 630 of the latch 645 may secure the fastener 335 within the aperture 615 during a low-energy front-body impact, as discussed in greater detail below.

In various embodiments, the mount 505 can include an opening 640. For example, the opening 640 may be an open volume of space located within the exterior of the mount 505, as shown in FIG. 6. The opening 640 may receive a portion of the shock absorber 510. For example, the shock absorber 510 may couple to one or more portions of the opening 640. In various embodiments, the opening 640 may abut, or extend adjacent to, a portion of the latch 645. For example, the opening 640 may include at least one portion that is exposed to at least one arm 630 of the latch 645, as shown in FIG. 6. In various embodiments, the opening 640 and the aperture 615 may be connected. For example, the mount 505 may include a channel 620 that extends between the aperture 615 and the opening 640. The channel 620 may be cylindrical in shape, as shown in FIG. 6. In various other embodiments, the channel 620 may include various other shapes.

While the exemplary embodiment shown in FIG. 6 includes an opening 640 in the general “D” shape, various other embodiments may include an opening of various other shapes including, but not limited to, rectangular, circular, triangular, or various other shapes. While the exemplary embodiment shown in FIG. 6 includes one opening 640, various other embodiments may include more or less openings 640. As shown in FIG. 6, the aperture 615 and the opening 640 may be integrally connected or attached by the channel 620 such that no partitions or walls separate the aperture 615 and the opening 640. In various other embodiments, the aperture 615 and the opening 640 may not be integrally connected. For example, the latch 645 may separate the aperture 615 from the opening 640.

The aperture 615 may be configured such that the mount 505 surrounds the fastener 335 with at least a portion of the fastener 335 exposed to an opening 640, as shown in FIG. 6. For example, the channel 620 may have a maximum width that is slightly smaller than the diameter of the fastener 335 within the aperture 615, such that the fastener 335 normally remains within the aperture 615 (e.g., under normal operating conditions, prior to impact, etc.).

As shown in FIG. 6, the shock absorber 510 may include an additional absorbing material 625 coupled with the shock absorber 510. For example, the additional absorbing material 625 may be integrally formed with one or more elements of the shock absorber 510. The additional absorbing material 625 may be coupled or attached to one or more elements of the shock absorber 510, as another example. The additional absorbing material 625 may be enclosed within one or more elements of the shock absorber 510, as yet another example.

In various embodiments, the mount 505 can be configured to deform (e.g., bend, twist, collapse, expand, etc.) upon impact. For example, the mount 505 may be configured to collapse upon impact, crash, or collision at the first end 105 (e.g., front end) of the electric vehicle 100. At very high impacts (e.g., large force, high energy, etc.), the mount 505 may be configured to deform such that the fastener 335 may exit the aperture 1015. For example, under high impact energy, the latch 645 of the mount 505 may expand such that the depth of the channel 620 exceeds the diameter of the fastener 335.

In various embodiments, the fastener 335 may exit the aperture 1015 and engage with a portion of the shock absorber 510. For example, the shock absorber 510 may receive a portion of the fastener 335 exiting the aperture 615. The shock absorber 510 and/or the additional absorbing material 625 may be configured to absorb a portion of the energy of impact. For example, the shock absorber 510 may collapse, dampen, or otherwise deform to absorb a portion of the force of the fastener 335 exiting the aperture 615 to facilitate absorbing the energy of impact and inhibiting further movement of the battery assembly 130. In such cases, the shock absorber 510 can absorb energy of impact to facilitate preventing the battery assembly 130 from damaging due to excessive movement or deceleration.

The mount 505 may deform such that the fastener 335 exits the aperture 615 at a threshold impact energy. In various embodiments, the threshold energy of impact is 10 KJ. In various embodiments, the energy of impact may be greater than 10 KJ. For example, the threshold energy of impact may be 15 KJ. The threshold energy of impact may be 20 KJ. In various embodiments, the energy of impact may be greater than 20 KJ. In various embodiments, the energy of impact may be another appropriate energy of a front-body impact of a vehicle 100. For example, the threshold impact energy may be the energy of impact at which the latch 645 opens (e.g., the channel 620 width exceeds the diameter of the fastener 335) such that the fastener 335 can exit the aperture 615.

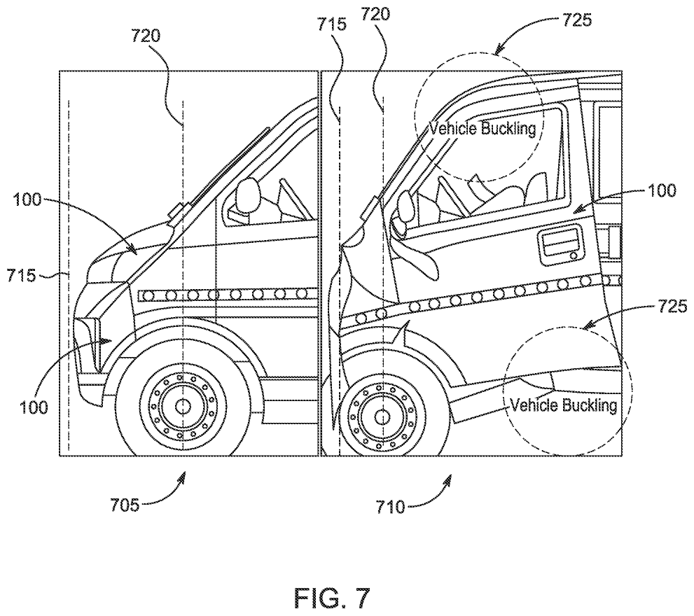

FIG. 7 depicts an exemplary implementation of a front-body (e.g., first end 105) impact of the electric vehicle 100 from a normal state 705 to a deformed state 710. As shown in FIG. 7, the distance between the collision point 715 and the secondary point 720 decreases from the normal state 705 to the deformed state 710 due to force of impact upon the vehicle 100 and deceleration, according to one exemplary implementation. The vehicle 100 may also experience one or more buckling zones 725, as depicted in the deformed state 710. One or more of the buckling zones 725 may occur near the battery assembly 130.

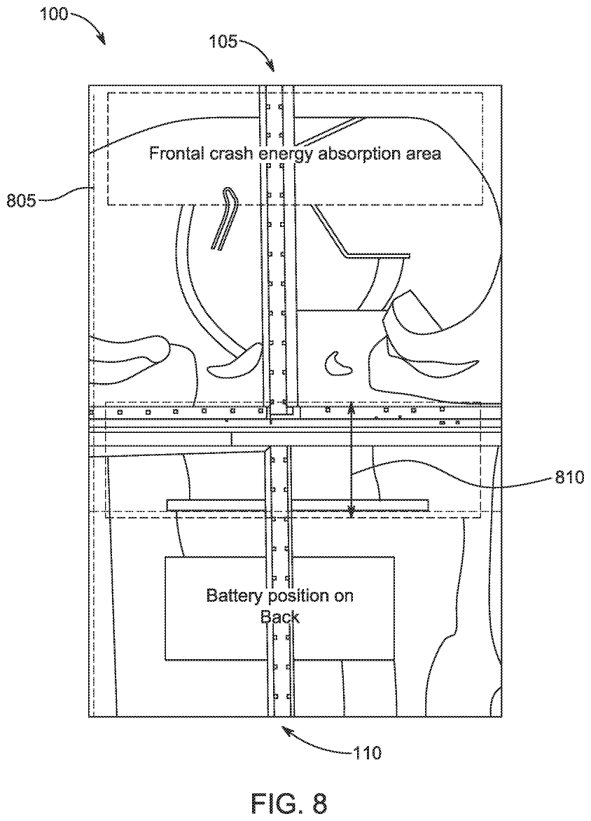

FIG. 8 further depicts an exemplary implementation of a front-body (e.g., first end 105) impact of the electric vehicle 100 from a rear view of the vehicle 100. In particular, FIG. 8 shows one example of the relative distance 810 the battery assembly 130 may move due to impact at the front of the electric vehicle 100 (e.g., as shown in frontal crash area 805). Accordingly, providing the battery mounting assembly 330 may facilitate absorbing a portion of the energy of impact to reduce the risk of damage from movement of the battery assembly 130.

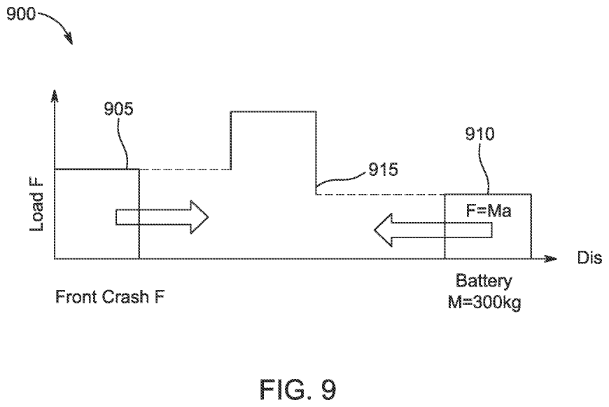

FIG. 9 depicts a graphical representation 900 of force of loading (e.g., impact) against displacement. Line 905 represents a general compression force upon the first end 105 of the vehicle 100 during impact (front-body). Line 910 represents an opposing force of the weight of the battery (e.g., the battery assembly 130) due to deceleration. The exemplary implementation shown in FIG. 9 depicts a battery assembly 130 of approximately 300 Kg of a vehicle 100 traveling at about 56 kilometers per hour (about 35 miles per hour). Accordingly, as the forces meet (e.g., at point 915), the forces create an impact energy of about 37 KJ loading on the longitudinal beams 205. In this example, the portion of the fastener 335 (e.g., coupled to a portion of the battery assembly 130) within the aperture 615 of the mount 505 would exit the aperture 615 and engage with the shock absorber 510. The shock absorber 510 may then deform (e.g., collapse, bend, etc.) to absorb a portion of the energy and facilitate reducing risk of damage to the battery assembly 130 (e.g., reducing vibration, excess movement, excess force, etc.).

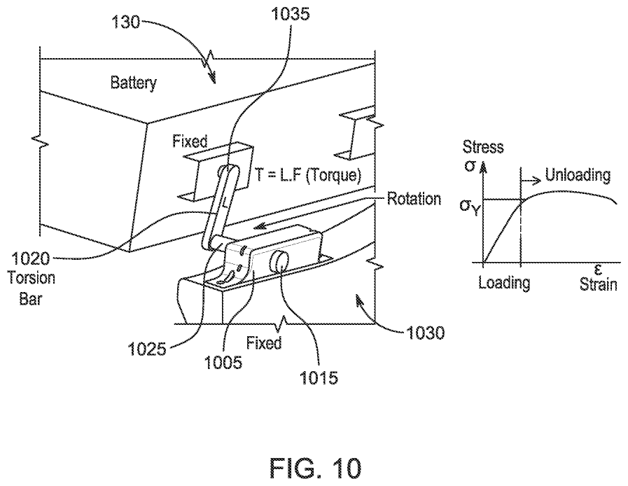

FIG. 10 shows an example of a battery mounting assembly 1030, according to an exemplary embodiment. The battery mounting assembly 1030 can include a mount 1005. For example, the mount 1005 may be configured to couple the battery assembly 130 with a beam of the electric vehicle 100, such as a longitudinal beam 205. The mount 1005 may be made of various metallic or non-metallic materials. For example, the mount 1005 may be made of aluminum, steel, various metal alloys, plastics, or fiber glass. The mount 1005 may include one or more components to facilitate coupling to the longitudinal beam 205. For example, the mount 1005 may couple to the longitudinal beam 205 through various fasteners. The mount 1005 may couple to the longitudinal beam 205 through various welding or adhesive means. In other embodiments, the mount 1005 may be integrally formed with the longitudinal beam 205. In still other embodiments, the battery mounting assembly 1030 may include various other elements to facilitate coupling the mount 1005 to the longitudinal beam 205 including, but not limited to, brackets, plates, and other similar fixtures.

The mount 1005 may include one or more apertures 1015. For example, the mount 1005 may include an aperture 1015 that is configured to receive a first fixed portion (e.g., a fastener 1025) of a torsion bar 1020. In various embodiments, the first fixed portion of the torsion bar 1020 may include one or more fasteners, shafts, rods, axles, or the like configured to couple the mount 1005 with the torsion bar 1020. In various embodiments, the fastener 1025 may be configured to remain fixed (e.g., not rotate) upon impact of the vehicle 100. In various embodiments, the fastener 1025 may couple with a rotatable portion of a torsion bar 1020. For example, the torsion bar 1020 may be a standard torsion bar made from various metallic or non-metallic materials. The torsion bar 1020 may couple with a second fixed portion 1035 to couple the torsion bar 1020 to the battery assembly 130. For example, the second fixed portion 1035 may include one or more fasteners, shafts, rods, axles, or the like configured to couple the torsion bar 1020 to the battery assembly 130. In various embodiments, the second fixed portion 1035 may be configured to remain fixed (e.g., not rotate) upon impact of the vehicle 100, while the torsion bar 1020 may be configured to rotate, twist, or otherwise deform upon impact of the vehicle 100.

While the exemplary embodiment depicted in FIG. 10 includes two fixed portions of the torsion bar 1020, various other embodiments may include more or less fixed portions. While the exemplary embodiments depicted in FIG. 10 includes fixed portions coupled directly with the torsion bar 1020, various other embodiments may include separate shafts, rods, or other similar components configured to couple the torsion bar 1020 with the battery mounting assembly 1030 and the battery assembly 130.

At very high impacts (e.g., large force, high energy, etc.), the torsion bar 1020 may be configured to deform (e.g., twist, rotate, etc.) such that the torsion bar 1020 facilitates absorbing energy of impact and relative movement between the mount 1005 and the battery assembly 130. This deformation may occur at a threshold impact energy. In various embodiments, the threshold energy of impact is 10 KJ. In various embodiments, the energy of impact may be greater than 10 KJ. For example, the threshold energy of impact may be 15 KJ. The threshold energy of impact may be 20 KJ. In various embodiments, the energy of impact may be greater than 20 KJ. In various embodiments, the energy of impact may be another appropriate energy of a front-body impact of a vehicle 100. For example, the threshold impact energy may be the energy of impact at which the torsion bar 1020 rotates. In various embodiments, upon impact of the threshold impact energy, the torsion bar 1020 can deform to reduce stress and strain of the battery assembly 130 and/or the mount 1005. In such cases, the torsion bar 1020 can absorb energy of impact to facilitate preventing the battery assembly 130 from damaging due to excessive movement or deceleration.

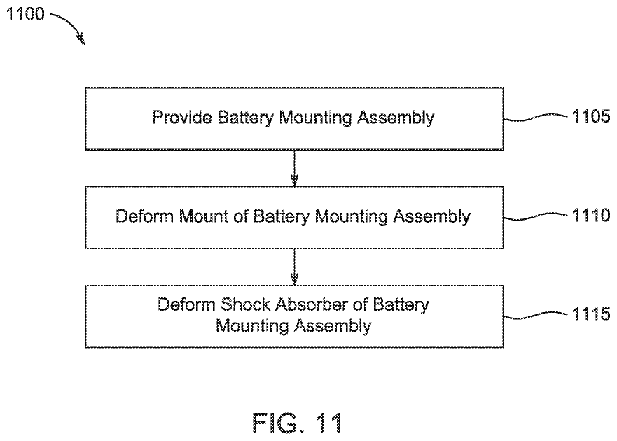

FIG. 11 depicts an illustration of a method 1100 of absorbing impact energy of an electric vehicle 100, according to an exemplary embodiment. As a brief overview, the method 1100 may include providing a battery mounting assembly 330, as depicted in act 1105. The method 1100 may include deforming a mount 505 of the battery mounting assembly 330, as depicted in act 1110. The method 1100 may include deforming a shock absorber 510 of the battery mounting assembly 330, as depicted in act 1115.

At act 1105, a battery mounting assembly 330 may be provided. For example, the battery mounting assembly 330 may facilitate coupling a battery assembly 130 to one or more components of the electric vehicle 100. The battery mounting assembly 330 may include a mount 505. For example, the mount 505 can include a frame or exterior configured to be coupled to a beam of the electric vehicle 100, such as a longitudinal beam 205. The mount 1005 can include an aperture 615. For example, the aperture 615 may be an opening, slot, puncture, or other volume of open or semi-open space for receiving a fastener 335 coupled to a portion of the battery assembly 130 (e.g., a shaft, beam, axle, etc.). The mount 505 can include a latch 645 having arms 630 that surround a portion of the aperture 615 to secure a portion of the fastener 335. The latch 645 may secure the fastener 335 within the aperture 615 during normal operation. In various embodiments, one or more arms 630 (e.g., projections) of the latch 645 may secure the fastener 335 within the aperture 615 during a low-energy front-body impact, as discussed in greater detail below.

In act 1110, the mount 505 may deform at a threshold impact energy. In various embodiments, the threshold impact energy is 10 KJ. In various other embodiments, the threshold impact energy may be greater than 10 KJ. For example, the threshold impact energy may be 15 KJ, 20 KJ, or another appropriate front-body impact energy. The mount 505 may deform at and/or near the aperture 615 such that the fastener 335 exits the aperture 615. In various embodiments, the opening 640 and the aperture 615 may be connected. For example, the mount 505 may include a channel 620 that extends between the aperture 615 and the opening 640. Under high impact energy, such as the threshold impact energy, the latch 645 of the mount 505 may expand such that the depth of the channel 620 exceeds the diameter of the fastener 335. For example, the mount 505 may deform at threshold impact energy such that the opening of the channel 620 exceeds the diameter of the fastener 335 and the fastener 335 can exit the aperture 615 (e.g., move towards the opening 640).

In act 1115, a shock absorber 510 of the battery mounting assembly 330 may deform. The shock absorber 510 can be coupled with, or integrally formed with, the mount 505. The shock absorber 510 may include one or more materials configured to deform upon impact including, but not limited to, plastic, metal, nomex honeycomb, resins, fiber glass, or the like. In various embodiments, the shock absorber 510 may receive a portion of the fastener 335 exiting the aperture 615 at or above the threshold impact energy. The shock absorber 510, and an additional absorbing material 625 coupled with the shock absorber 510, may be configured to absorb a portion of the energy of impact. For example, the shock absorber 510 may collapse, dampen, or otherwise deform to absorb a portion of the force of the fastener 335 exiting the aperture 615 to facilitate absorbing the energy of impact and inhibiting further movement of the battery assembly 130. In such cases, the shock absorber 510 can absorb energy of impact to facilitate preventing the battery assembly 130 from damaging due to excessive movement or deceleration.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Language such as the phrases “at least one of X, Y, and Z” and “at least one of X, Y, or Z,” unless specifically stated otherwise, are understood to convey that an element may be either X; Y; Z; X and Y; X and Z; Y and Z; or X, Y, and Z (i.e., any combination of X, Y, and Z). Thus, such language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the electric vehicle 100 and components thereof (e.g., the battery mounting assembly 330, the wheels 120, etc.) as shown in the various exemplary embodiments is illustrative only. Additionally, any element disclosed in one embodiment may be incorporated or utilized with any other embodiment disclosed herein.

What is claimed is:

1. A battery mounting assembly for an electric vehicle, comprising:
a mount including an aperture configured to receive a portion of a fastener;
a shock absorber coupled to the mount;
wherein the mount is configured to couple to a beam of the electric vehicle; and
wherein the mount is configured such that the portion of the fastener exits the aperture at a threshold impact energy.

2. The battery mounting assembly of claim 1, wherein the mount includes a latch adjacent the aperture such that the latch secures the portion of the fastener in the aperture at an impact energy that is less than the threshold impact energy.

3. The battery mounting assembly of claim 2, wherein the latch includes a plurality of arms surrounding a portion of the aperture to facilitate securing the portion of the fastener in the aperture.

4. The battery mounting assembly of claim 2, wherein the mount includes an opening abutting a portion of the latch configured to receive a portion of the shock absorber.

5. The battery mounting assembly of claim 4, wherein the mount includes a channel that extends between the aperture and the opening.

6. The battery mounting assembly of claim 1, wherein the threshold impact energy is produced by a front-body impact.

7. The battery mounting assembly of claim 1, wherein the shock absorber is configured to receive the portion of the fastener exiting the aperture at the threshold impact energy.

8. The battery mounting assembly of claim 1, wherein the threshold impact energy is greater than 10 KJ.

9. The battery mounting assembly of claim 1, wherein the threshold impact energy is greater than 20 KJ.

10. The battery mounting assembly of claim 1, further comprising a fixture configured to couple the mount to the beam of the electric vehicle.

11. The battery mounting assembly of claim 1, wherein the fastener is configured to couple to a shaft of the electric vehicle.

12. The battery mounting assembly of claim 11, wherein the shaft is configured to couple to a battery assembly.

13. An electric vehicle, comprising:
a first end and an opposing second end;
a plurality of battery mounting assemblies;
a battery assembly coupled to a portion of each of the plurality of battery mounting assemblies;
wherein each of the plurality of battery mounting assemblies includes:
a mount having an aperture configured to receive a portion of a fastener coupled to a portion of the battery assembly, and
a shock absorber coupled to the mount; and
wherein the mount is configured such that the portion of the fastener exits the aperture at a threshold impact energy.

14. The electric vehicle of claim 13, wherein the mount includes an opening configured to receive a portion of the shock absorber.

15. The electric vehicle of claim 14, wherein the mount includes a plurality of projections surrounding a portion of the aperture such that the plurality of projections secure the portion of the fastener in the aperture at an impact energy that is less than the threshold impact energy.

16. The electric vehicle of claim 15, wherein the mount includes a channel extending between the aperture and the opening.

17. The electric vehicle of claim 13, wherein the shock absorber is configured to receive the portion of the fastener at the threshold impact energy.

18. The electric vehicle of claim 13, wherein the threshold impact energy is greater than 10 KJ.

19. The electric vehicle of claim 13, wherein the threshold impact energy is greater than 20 KJ.

20. A battery mounting assembly for an electric vehicle, comprising:
a mount including an aperture configured to receive a portion of a fastener;
a torsion bar configured to couple to a portion of the fastener;
wherein the torsion bar is configured to rotate at a threshold impact energy; and
wherein the torsion bar is configured to couple to a portion of a battery assembly of the electric vehicle.

21. The battery mounting assembly of claim 20, wherein the mount is configured to couple to a portion of a beam of the electric vehicle.

22. The battery mounting assembly of claim 20, wherein the threshold impact energy is greater than 10 KJ.

23. The battery mounting assembly of claim 20, wherein the threshold impact energy is greater than 20 KJ.

24. A method of absorbing energy of a front-body impact of an electric vehicle, comprising:
providing a battery mounting assembly including a mount having an aperture configured to receive a portion of fastener and a shock absorber coupled to the mount;
deforming, via the aperture, the mount at a threshold impact energy such that the fastener is configured to exit the aperture; and
receiving, via the shock absorber, the portion of the fastener.

25. The method of claim 24, wherein the threshold impact energy is greater than 10 KJ.

26. The method of claim 24, wherein the threshold impact energy is greater than 20 KJ.
